(19) United States
(12) Patent Application Publication
(10) Pub. No.: US 2011/0202590 A1
(43) Pub. Date: Aug. 18, 2011

(54) METHOD OF RANDOMIZING OPERATION START POINT IN TIME OF MACHINE TYPE TERMINAL IN MOBILE COMMUNICATION SYSTEM

(75) Inventors: Jae Sheung SHIN, Daejeon (KR); Hyun Seo PARK, Daejeon (KR); Kyung Sook KIM, Daejeon (KR); Sung Gu CHOI, Daejeon (KR); Soon Gi PARK, Daejeon (KR); Yeon Seung SHIN, Daejeon (KR); Yeong Jin KIM, Daejeon (KR)

(73) Assignee: Electronics and Telecommunications Research Institute, Daejeon (KR)

(21) Appl. No.: 13/028,721

(22) Filed: Feb. 16, 2011

(30) Foreign Application Priority Data
Feb. 17, 2010 (KR) 10-2010-0014343
Feb. 16, 2011 (KR) 10-2011-0013754

(51) Int. Cl. G06F 15/16

(52) U.S. Cl. 709/202

(57) ABSTRACT

Provided is a machine type communication terminal that may decrease load of a network and a server by performing an operation at different points in times. The machine type communication terminal may transmit data to the server via the network. A plurality of machine type communication terminals, the network, and the server may randomize operation start points in times of the machine type communication terminals in order to differentiate the operation start points in times.

### CROSS-REFERENCE TO RELATED APPLICATION

This application claims the benefit of Korean Patent Application Nos. 10-2010-0014343 and 10-2011-0013754 filed on Feb. 17, 2010 and Feb. 16, 2011, respectively, in the Korean Intellectual Property Office, the disclosure of which is incorporated herein by reference.

### BACKGROUND

1. Field of the Invention

The present invention relates to a machine type terminal and an application server communicating with the machine type terminal, and more particularly, to a method of determining an operation start point in time of a machine type terminal.

2. Description of the Related Art

A machine-based communication service indicates a service for exchanging information between machine equipments, or between a machine equipment and a user. Machine-based communication may be performed using a server and a specially developed terminal, for example, a communication terminal with a low data rate.

The machine-based communication may be applicable to fields needing a periodical communication, however, transmitting a relatively small amount of data. For example, a safety diagnostic apparatus may be installed in each portion of a bridge to inspect the safety of the bridge and the like. Each corresponding safety diagnostic apparatus may transmit a safety diagnostic result to an application server using machine type terminals.

The machine-based communication may be performed in a time zone promised between terminals, or between a terminal and a server. Specifically, a machine type terminal may transmit data to the application server in a predetermined time zone.

When a plurality of machine type terminals implementing an application simultaneously transmits data in the predetermined time zone, load may instantaneously increase in both a network in which data is transmitted and the application server to process the data, whereby a bottle neck phenomenon may occur or appropriate processing may not be performed.

### SUMMARY

An aspect of the present invention provides a method that may decrease load of a communication network or an application server by randomizing an operation start point in time of a machine type terminal.

Another aspect of the present invention provides a method that may cope with an operation of a machine type terminal using a communication network or an application server with a relatively small processing capacity by controlling an operation start point in time of the machine type terminal.

According to an aspect of the present invention, there is provided an operation method of a terminal, including: standing by for a length of a standby time less than a length of an operation time period from a start point in time of the operation time period; and transmitting data to an application server via a network apparatus after the length of the standby time.

According to another aspect of the present invention, there is provided an operation method of an application server, including: receiving, from each of a plurality of terminals, data transmitted after a length of a standby time randomly determined by each of the terminals within a predetermined operation time period.

According to still another aspect of the present invention, there is provided an operation method of an application server, including: randomly determining a length of a standby time less than a length of an operation time period with respect to each of a plurality of terminals; transmitting an operation start request with respect to each of the terminals after the length of the randomly determined standby time from a start point in time of the operation time period; and receiving data from each of the terminals in response to the operation start request.

According to yet another aspect of the present invention, there is provided an operation method of a terminal, including: receiving an operation start request transmitted with respect to each of a plurality of terminals, after a length of a standby time randomly determined with respect to each of the terminals within an operation time period; and transmitting data to an application server in response to the operation start request.

According to embodiments of the present invention, it is possible to decrease load of a communication network or an application server by randomizing an operation start point in time of a machine type terminal.

Also, according to embodiments of the present invention, it is possible to cope with an operation of a machine type terminal using a communication network or an application server with a relatively small processing capacity by controlling an operation start point in time of the machine type terminal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an operation of a machine type terminal and an application server according to an embodiment of the present invention;

FIG. 2 is a flowchart illustrating an operation of a machine type terminal and an application server according to an embodiment of the present invention;

FIG. 3 is a flowchart illustrating an operation of a machine type terminal and an application server according to another embodiment of the present invention;

FIG. 4 is a flowchart illustrating an operation of a machine type terminal and an application server according to still another embodiment of the present invention;

FIG. 5 is a flowchart illustrating an operation method of a machine type terminal according to an embodiment of the present invention;

FIG. 6 is a flowchart illustrating an operation method of an application server according to an embodiment of the present invention;

FIG. 7 is a flowchart illustrating an operation method of an application server according to another embodiment of the present invention;

FIG. 8 is a flowchart illustrating an operation of a machine type terminal according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

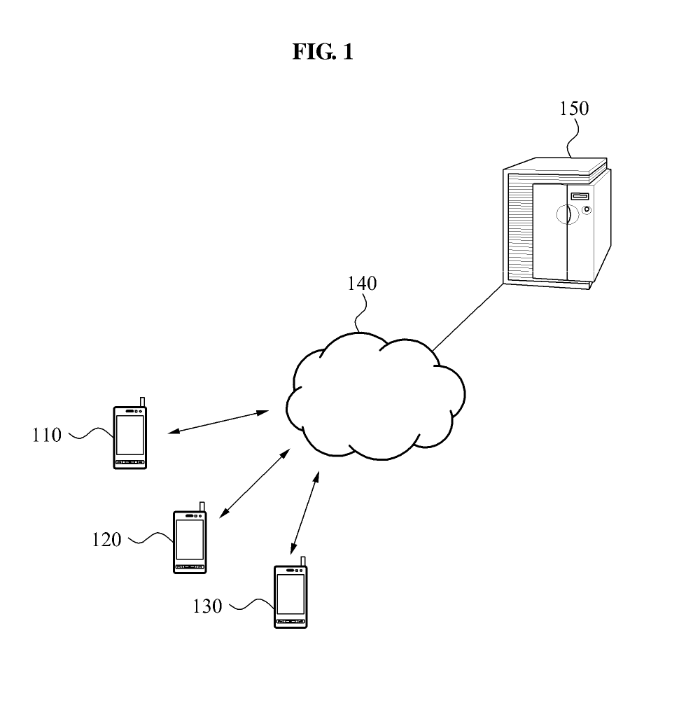

FIG. 1 is a diagram illustrating an operation of a machine type terminal and an application server according to an embodiment of the present invention.

Referring to FIG. 1, each of machine type terminals 110, 120, and 130 may correspond to a terminal that generally operates based on a machine-to-machine communication, which is different from a general terminal performing communication according to an intent or a manipulation of a user. Hereinafter, even though the term ‘terminal’ is used in the present specification for concise description, the terminal indicates the machine type terminal instead of the general terminal.

Each of the machine type terminals 110, 120, and 130 may transmit data to an application server 150 over a communication network 140. Each of the machine type terminals 110, 120, and 130 may receive data from the application server 150 over the communication network 140.

Each of the machine type terminals 110, 120, and 130 may intensively perform an operation in a predetermined time zone. For example, to inspect the safety of a bridge and the like, a safety diagnostic apparatus may be installed in each portion of the bridge. Each corresponding safety diagnostic apparatus may transmit a safety diagnostic result to the application server 150 in a predetermined time zone of a day using the machine type terminals 110, 120, and 130. When the machine type terminals 110, 120, and 130 installed in the bridge simultaneously transmit safety diagnostic results, the communication network 140 and the application server 150 may need to instantaneously process a relatively large amount of load.

Considering features of the safety diagnostic apparatuses installed in the bridge, the transmission of the safety diagnostic results may be performed only once or twice a day and thus, a usage frequency of the communication network 140 may be significantly low. However, when the plurality of machine type terminals 110, 120, and 130 transmits data at the instantaneously same point in time, the communication network 140 and the application server 150 with a relatively great processing capacity may need to be employed, which may be inefficient.

According to an embodiment of the present invention, an operation start point in time of each of the machine type terminals 110, 120, and 130 may be differently determined. Specifically, since operation start points in times of the machine type terminals 110, 120, and 130 are different from each other, load of the communication network 140 and the application server 150 may be distributed. Accordingly, it is possible to efficiently cope with the machine type terminals 110, 120, 130 by employing only the communication network 140 and the application server 150 with a relatively small capacity.

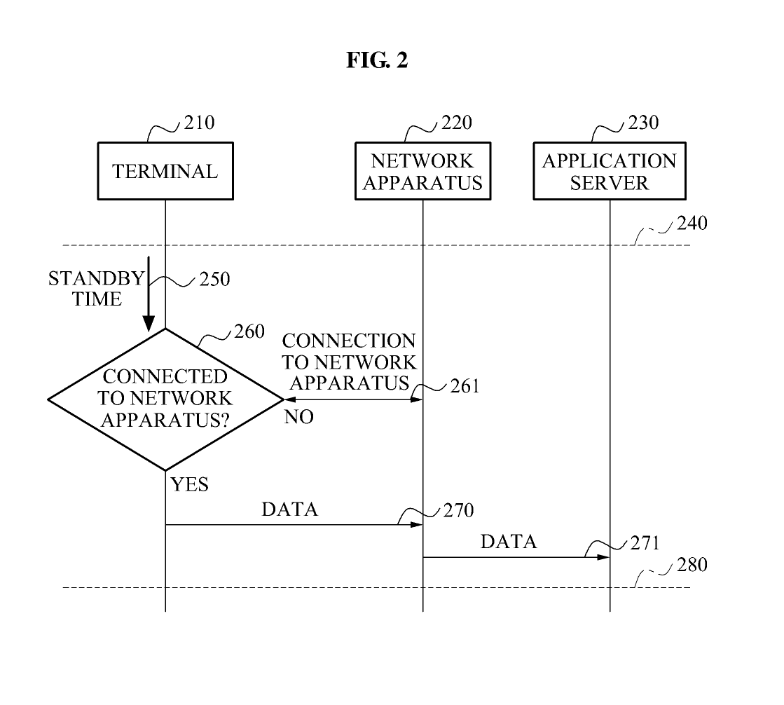

FIG. 2 is a flowchart illustrating an operation of a terminal 210 and an application server 230 according to an embodiment of the present invention. Referring to FIG. 2, the terminal 210 may be an entity for randomizing an operation start point in time of the terminal 210.

The terminal 210 may stand by for a length of a standby time 250 from a start point in time 240 of an operation time period. The length of the standby time 250 may be randomly determined with respect to each terminal. The terminal 210 may determine a random length of the standby time 250 based on a length of time from the start point in time 240 to an end point in time 280 of the operation time period.

In operation 260, the terminal 210 may determine whether the terminal 210 is connected to a network apparatus 220. When the terminal 210 is not connected to the network apparatus 220, the terminal 210 may perform a connection to the network apparatus 220. The above operation may be performed according to a random access procedure of a cellular network.

When the terminal 210 is connected to the network apparatus 220, or when the terminal 210 performs the connection to the network apparatus 220 in operation 261, the terminal 210 may perform a predetermined operation in operation 270. For example, the predetermined operation may be transmitting of data to the network apparatus 220.

In operation 271, the network apparatus 220 may transmit the received data to the application server 230. A service GPRS support node (SGSN)/serving gateway and the like constituting a Third Generation Partnership Project (3GPP) radio network may be employed as the network apparatus 220 of FIG. 2.

FIG. 2 illustrates an embodiment in which a terminal determines a random length of a standby time. A plurality of terminals may transmit data to an application server at a predetermined point in time of an operation time period. In this case, a network apparatus relaying the data may need to instantaneously process a large amount of load. Considering features of a machine type terminal, load may not be great in other time intervals. Despite of the above, when the network apparatus and the application server with a relatively great capacity need to be employed due to instantaneous load increase during the operation time period, it will be a great waste.

In the embodiment of FIG. 2, each terminal may determine the random length of the standby time. Since each terminal determines the random length of the standby time without considering a length of a standby time determined by another terminal, the standby time determined by each terminal may have a different length. In addition, since each terminal initiates an operation after the length of the standby time, an operation start point in time of each terminal may be different. Therefore, instantaneous load occurring in the network apparatus or the application server due to an operation of the terminal may be significantly small. Accordingly, even though the network apparatus or the application server with a relatively small capacity is employed, it is possible to efficiently cope with the operation of each terminal.

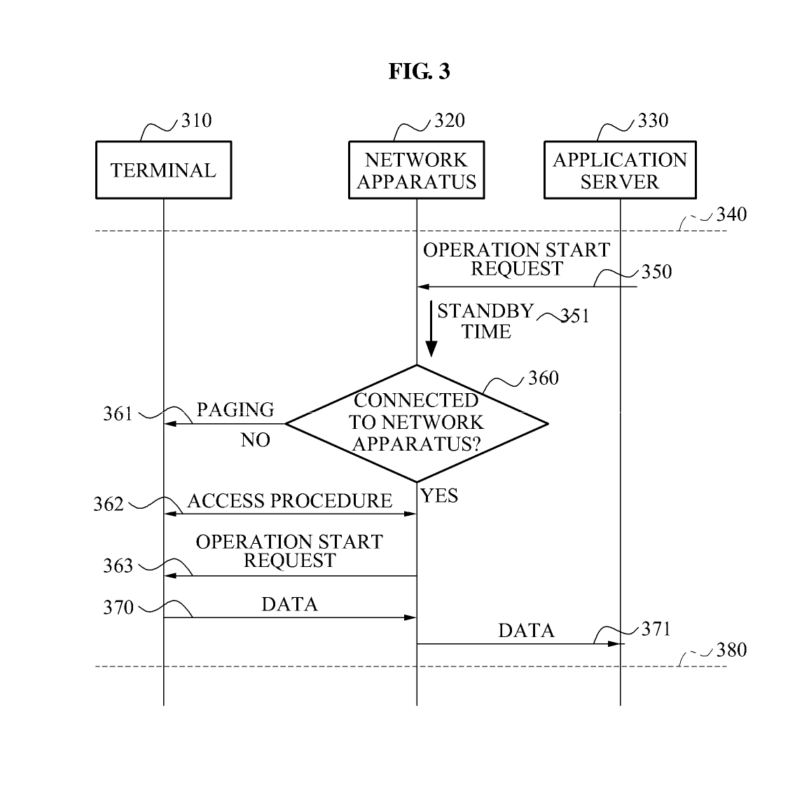

FIG. 3 is a flowchart illustrating an operation of a terminal 310 and an application server 330 according to another embodiment of the present invention. Referring to FIG. 3, a network apparatus 320 may be an entity for randomizing an operation start point in time of the terminal 310. For example, an SGSN (Serving GPRS Support Node)/MME (Mobile Management Entity) and the like constituting a 3GPP radio network may be employed for the network apparatus 320.

The application server 330 may transmit an operation start request 350 with respect to the terminal 310 to the network apparatus 320 at a start point in time 340 of an operation time period.

The network apparatus 320 may determine a random length of a standby time 251 based on a length of time from the start point in time 340 of the operation time period to an end point in time 380 of the operation time period. Here, the length of the standby time 351 determined with respect to each terminal may be different.

In operation 360 after the random length of the standby time 351, the network apparatus 320 may determine whether the terminal 310 is connected to the network apparatus 320 in operation 360. When the terminal 310 is not connected to the network apparatus 320, the network apparatus 320 may transmit a paging signal and the like in operation 361. The terminal 310 receiving the paging signal may perform a connection to the network apparatus 320 in operation 362. The above operation may be performed according to a random access procedure of a cellular network.

When the terminal 310 is connected to the network apparatus 320, the network apparatus 320 may transmit, to the terminal 310, the operation start request received from the application server 330 in operation 363.

In operation 370, the terminal 310 may transmit data to the network apparatus 320 in response to the operation start request.

In operation 371, the network apparatus 320 may transmit, to the application server 370, the data received from the terminal 310.

According to the embodiment of FIG. 3, a network apparatus may determine a random length of a standby time with respect to each terminal. Since each terminal starts to operate after the random length of the standby time, an operation start point in time of each terminal may be different. Therefore, instantaneous load occurring in the network apparatus or an application server due to the operation of the terminal may be significantly small. Accordingly, even though the network apparatus or the application server with a relatively small capacity is employed, it is possible to efficiently cope with the operation of each terminal.

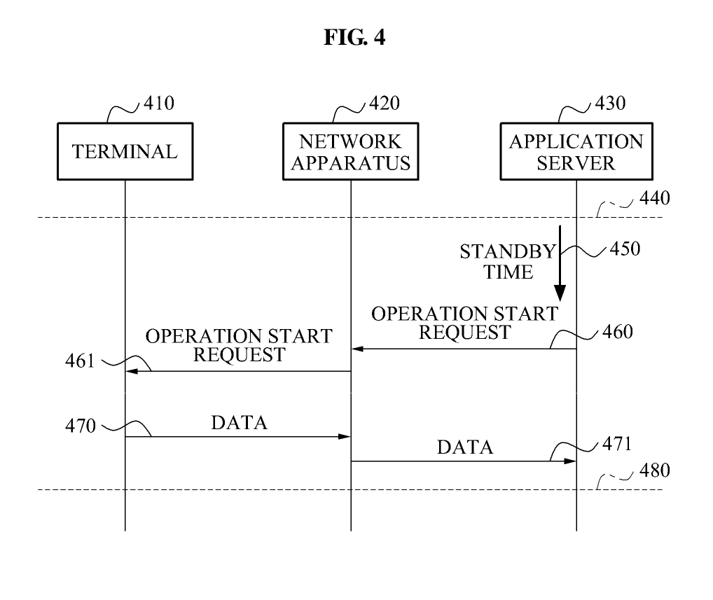

FIG. 4 is a flowchart illustrating an operation of a terminal 410 and an application server 430 according to still another embodiment of the present invention. Referring to FIG. 4, the application server 430 may be an entity of randomizing an operation start point in time of the terminal 410.

The application server 430 may determine a random length of a standby time 450 based on a length of time from a start point in time 440 of an operation time period to an end point in time 480 of the operation time period. The length of the standby time 450 determined with respect to each terminal may be different.

The application server 430 may stand by for the length of the standby time 450 that is different for each terminal.

In operation 460, the application server 430 may transmit, to a network apparatus 420, an operation start request with respect to the terminal 410. For example, an SGSN/serving gateway and the like constituting a 3GPP radio network may be employed for the network apparatus 420.

In operation 461, the network apparatus 420 may transmit, to the terminal 410, an operation start request with respect to the terminal 410.

In operation 470, the terminal 410 may transmit data to the network apparatus 420 in response to the operation start request.

In operation 471, the network apparatus 420 may transmit, to the application server 430, data received from the terminal 410.

According to the embodiment of FIG. 4, an application server may determine a random length of a standby time with respect to each terminal. Since the application server starts to operate after the random length of the standby time with respect to each terminal, an operation start point in time of each terminal may be different. In addition, respective operations 461 though 471 may be different for each terminal.

Therefore, instantaneous load occurring in the network apparatus or an application server due to the operation of the terminal may be significantly small. Accordingly, even though the network apparatus or the application server with a relatively small capacity is employed, it is possible to efficiently cope with the operation of each terminal.

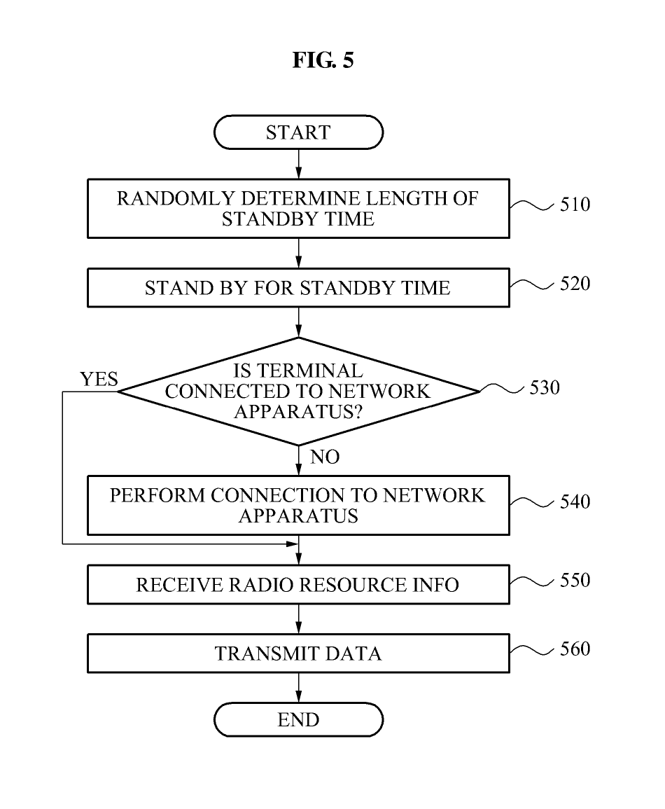

FIG. 5 is a flowchart illustrating an operation method of a terminal according to an embodiment of the present invention.

In operation 510, the terminal may determine a length of a standby time with respect to the terminal. The terminal may need to repeat a predetermined operation in each operation time period repeated at predetermined intervals. In this case, the terminal may determine the length of the standby time so that the predetermined operation may be completed for the operation time period, based on a length of the operation time period and a length of time used for transmitting data.

For example, the terminal may transmit predetermined data to an application server by using ‘one day’ as an interval. In this case, the terminal may transmit data to the application server in a predetermined time zone, for example, for one hour from 3 a.m. to 4 a.m. Here, a length of an operation time period may be one hour.

A length of time used when the terminal substantially performs a predetermined operation may be shorter than the length of the operation time period. Specifically, even though the length of the operation time period is one hour, five minutes may be used for the terminal to transmit data. In this case, the terminal may randomly determine a length of a standby time to be between zero minutes and 55 minutes. Each of a plurality of terminals transmitting data to the same application server may determine the length of the standby time to have a different value.

In operation 520, the terminal may stand by for the length of the standby time.

In operation 530, the terminal may determine whether the terminal is connected to a network apparatus. When the terminal is not connected to the network apparatus, the terminal may perform a connection to the network apparatus in operation 540. According to an aspect, based on a length of time used when the terminal performs the connection to the network apparatus, the terminal may determine the length of the standby time.

In operation 550, the terminal may receive information associated with a radio resource from the application server or the network apparatus constituting a network. When a plurality of terminals transmits data to the application server, the application server may assign a dedicated radio resource uniquely determined with respect to each terminal. Each terminal may receive information associated with the dedicated radio resource. In this case, each terminal may transmit data to the network apparatus using the dedicated radio resource in operation 560.

The application server may assign a common radio resource that may be shared by the plurality of terminals. In this case, each terminal may transmit data to the network apparatus using the common radio resource assigned to the plurality of terminals.

The network apparatus may transmit the received data to the application server.

According to the embodiment of FIG. 5, terminals transmitting data to the same application server may randomly determine a length of a corresponding standby time. For example, a first terminal may determine the length of standby time as five minutes and a second terminal may determine the length of the standby time as thirty minutes. In this case, when a length of time used for the terminal to perform a predetermined operation is five minutes, the second terminal may perform an operation after an operation of the first terminal is completed.

Accordingly, load occurring due to the terminal may be distributed and it is possible to cope with the operation of the terminal using the network apparatus or the application server with a relatively small capacity.

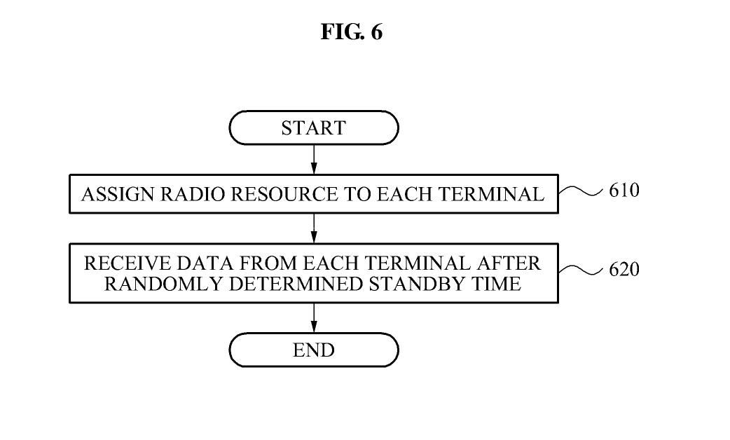

FIG. 6 is a flowchart illustrating an operation method of an application server according to an embodiment of the present invention.

In operation 610, the application server may assign a radio resource with each of a plurality of terminals. Instead of the application server, a network apparatus constituting a network may also assign the radio resource to each of the terminals.

The application server may assign a dedicated radio resource uniquely determined with respect to each terminal. The application server may assign a common radio resource that may be shared by the plurality of terminals.

In operation 610, the application server may transmit, to each of the terminals, information associated with the assigned radio resource.

In operation 620, the application server may receive data from each of the terminals. The application server may receive data from each of the terminals after the length of the standby time randomly determined by each of the terminals. Each of the terminals may determine the length of the standby time within a length of a predetermined operation time period. The embodiment of determining, by each of the terminals, the length of the standby time within the length of the operation time period is described above and thus, further detailed description will be omitted here.

The operation time period may be repeated at predetermined time intervals. In operation 620, the application server may receive data from each of the terminals using the assigned radio resource.

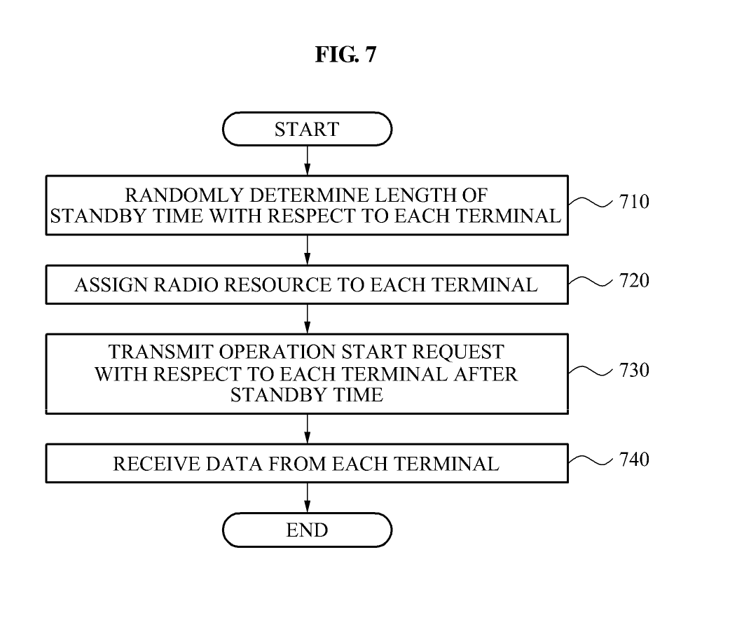

FIG. 7 is a flowchart illustrating an operation method of an application server according to another embodiment of the present invention.

In operation 710, the application server may determine a length of a standby time with respect to each of a plurality of terminals. The application server may differently determine the length of the standby time with respect to each of the terminals, and may also randomly determine the length of the standby time.

The application server may receive data from each of the terminals only for a predetermined operation time period. In this case, the application server may determine the length of the standby time with respect to each of the terminals so that the length of the standby time may be less than the length of the operation time period.

The application server may determine the length of the standby time so that an operation of each of the terminals may be completed after the length of the standby time within the predetermined operation time period, based on the length of the operation time period, a length of time used for transmitting an operation start request, and a length of time used for receiving data in response to the operation start request.

The operation time period may be repeated at predetermined intervals. In this case, the application server may determine a standby time of a predetermined terminal to have a different length with respect to each operation time period.

In operation 720, the application server may assign a radio resource to each of the terminals.

The application server may assign a dedicated radio resource uniquely determined with respect to each of the terminals. The application server may assign a common radio resource that may be shared by the plurality of terminals.

In operation 730, the application server may transmit an operation start request to each of the terminals. The application server may transmit the operation start request after the length of the standby time determined in operation 710 from a start point in time of the operation time period.

The application server may transmit an operation start request to the network apparatus. The network apparatus may transmit the operation start request to each of the terminals.

In operation 740, the application server may receive data from each of the terminals in response to the operation start request. When a dedicated radio resource is assigned to each of the terminals in operation 720, the application server may receive the data using the dedicated radio resource. When data is received using the dedicated radio resource, the data transmitted from the terminals may not collide with each other. Accordingly, the reliability of data transmission may be enhanced. When a common radio resource that may be shared by the plurality of terminals is assigned, the application server may receive data using the common radio resource. Since the plurality of terminals shares the radio resource, it is possible to effectively use the radio resource.

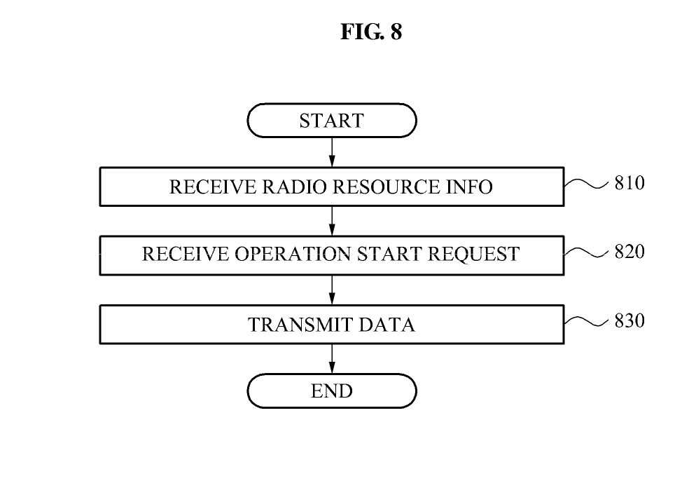

FIG. 8 is a flowchart illustrating an operation of a terminal according to another embodiment of the present invention.

In operation 810, the terminal may receive information associated with a radio resource. An application server or a network apparatus may assign a radio resource to the terminal, and the terminal may receive information associated with the assigned radio resource from the application server or the network apparatus.

The application server may assign a dedicated radio resource to each of terminals. In this case, a different radio resource may be assigned to each of the terminals.

The application server may assign a common radio resource that may be shared by the plurality of terminals.

In operation 820, the terminal may receive an operation start request from the application server. The application server may transmit the operation start request with respect to each of the terminals after a length of a standby time, determined with respect to each of the terminals, from a start point in time of an operation time period.

The application server may randomly determine the length of the standby time with respect to each of the terminals. The application server may determine the length of the standby time so that an operation of each of the terminals may be completed after the length of the standby time within the operation time period, based on all of a length of the operation time period, a length of time used for transmitting the operation start request from the application server to the terminal, and a length of time used for transmitting data from the terminal to the application server.

In operation 830, the terminal may transmit data to the application server in response to the operation start request. When the application server assigns a dedicated radio resource to each of the terminals, each of the terminals may transmit data using the dedicated radio resource. When data is transmitted using the dedicated radio resource, data transmitted from the terminals may not collide with each other and thus, the reliability of data transmission may be enhanced. When the application server assigns a common radio resource that may be shared by the plurality of terminals, each of the terminals may transmit data using the common radio resource. Since the plurality of terminals shares the radio resource, it is possible to effectively use the radio resource.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An operation method of a terminal, comprising:
standing by for a length of a standby time less than a length of an operation time period from a start point in time of the operation time period; and
transmitting data to an application server via a network apparatus after the length of the standby time.

2. The method of claim 1, further comprising:
determining whether the terminal is connected to the network apparatus after the length of the standby time; and
connecting the terminal to the network apparatus depending on the determination result.

3. The method of claim 1, further comprising:
receiving, from the network apparatus, information regarding a radio resource uniquely assigned to the terminal,
wherein the transmitting comprises transmitting the data using the radio resource.

4. The method of claim 1, further comprising:
randomly determining the length of the standby time based on the length of the operation time period and a length of a time used for transmitting the data.

5. The method of claim 1, wherein the operation time period is repeated at predetermined intervals.

6. An operation method of an application server, comprising:
receiving, from each of a plurality of terminals, data transmitted after a length of a standby time randomly determined by each of the terminals within a predetermined operation time period.

7. The method of claim 6, wherein the operation time period is repeated at predetermined time intervals.

8. The method of claim 6, wherein the receiving comprises receiving the data using a radio resource uniquely assigned to each of the terminals.

9. An operation method of an application server, comprising:
randomly determining a length of a standby time less than a length of an operation time period with respect to each of a plurality of terminals;
transmitting an operation start request with respect to each of the terminals after the length of the randomly determined standby time from a start point in time of the operation time period; and
receiving data from each of the terminals in response to the operation start request.

10. The method of claim 9, further comprising:
assigning a unique radio resource to each of the terminals,
wherein the receiving comprises receiving the data using the radio resource.

11. The method of claim 9, wherein the determining comprises determining the length of the standby time based on the length of the operation time period, a length of a time used for transmitting the operation start request, and a length of a time used for receiving the data.

12. The method of claim 9, wherein the operation time period is repeated at predetermined intervals.

13. An operation method of a terminal, comprising:
receiving an operation start request transmitted with respect to each of a plurality of terminals, after a length of a standby time randomly determined with respect to each of the terminals within an operation time period; and
transmitting data to an application server in response to the operation start request.

14. The method of claim 13, wherein the transmitting comprises transmitting the data using a radio resource uniquely assigned with respect to each of the terminals.

15. The method of claim 13, wherein the length of the standby time is determined based on a length of the operation time period, a length of a time used for transmitting the operation start request, and a length of a time used for transmitting the data.
